(19) United States
(12) Patent Application Publication
(10) Pub. No.: US 2009/0213740 A1
(43) Pub. Date: Aug. 27, 2009

(54) Measurement Based Link Capacity for Multiple Interferers in an 802.11-Based Wireless Network

(75) Inventors: Samrat Ganguly, Monmouth Junction, NJ (US); Anand Kashyap, Stony Brook, NY (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/036,328

(22) Filed: Feb. 25, 2008

(51) Int. Cl. H04L 12/26

(52) U.S. Cl. 370/252

(57) ABSTRACT

A method according to the invention includes determining a PHY layer model for a single interferer in an 802.11 wireless network responsive to an input of measured pair wise of at least one of a delivery ratio and received signal strength RSSI values in the 802.11 wireless network; ascertaining a deferral probability for a given node in the network in the presence of multiple interferers in a MAC layer model of the 802.11 network responsive to the determining step in the PHY layer model; and deriving from the ascertaining step at least one of sending capacity in the presence of multiple interferers, packet collision probability in the presence of multiple interferers and available capacity in a given link for a corresponding link delivery ratio.

### BACKGROUND OF THE INVENTION

The present invention relates generally to 802.11-based wireless communications, and more particularly, to a measurement based approach to assessing link capacity for multiple interferers in 802.11-based wireless networks.

### BACKGROUND OF THE INVENTION

Practical models for predicting the wireless link capacity are crucial to an efficient operation and deployment of wireless network. The performance of network protocols and algorithms such as QoS routing, load balancing, admission control and channel assignment can be significantly improved with an accurate model of link capacity. Capacity models are also required as analysis tools to efficiently explore a gamut of network configurations and traffic load scenarios for performance evaluation.

Recently, the proliferation of 802.11 based wireless LAN and mesh networks has lead to several research efforts focussing on predicting the capacity of an 802.11-specific wireless link. What makes the accurate estimation of 802.11 link capacity an inherently challenging task is that the link capacity is an ensemble effect of physical layer behavior, complex CSMA-based MAC layer interaction, and interference effect from multiple active sources.

Characterizing the impact of interference: Interference impacts the sender by reducing its maximum sending rate as determined by the CSMA based 802.11 MAC layer interaction. Interference also impacts the receiver by reducing the probability of successful packet reception by causing collisions at the receiver. The specifics of the MAC protocol (e.g., random backoff) as well as implementation-specific physical layer components such as carrier sense threshold (i.e., what received power must be sensed to decide that the medium is busy) and packet capture threshold (i.e., threshold of signal-to-noise-plus-interference ratio to be able to receive a packet successfully) are other factors which affect the interference-limited capacity of a wireless link.

Existing models for single-hop and multi-hop 802.11 networks suffer from the limitation that they are based on the assumption of idealized channel condition where each link is lossless. They also assume that interference is ‘pairwise’ (i.e., happens between node or link pairs only) and ‘binary’ (i.e., interference is either present or absent). However, recent measurement studies have shown that interference is neither pairwise nor binary. The effect of multiple interferers and effect of realistic channel and interface behavior must be accounted for accurate modeling.

Measurement-based capacity model: Evidently, a model built on actual measurement of appropriate metrics can avoid the unrealistic assumptions. However, such models must be of a reasonable measurement complexity to be practical and must also be robust to potentially changing operating conditions. To that end, a recent model based on measuring just signal strengths between node pairs has been proposed to predict capacity of a link. That model however is described for the case of single interferer and does not address the general and realistic case where the effect of simultaneous multiple interferers on link capacity must be considered. The case for multiple interferers is challenging because of the following reasons. The model has to consider every possible combination of interfering transmitters, because any number of them could be transmitting at a time. The model also has to capture the effect of any possible traffic load scenarios at the interferers.

The capacity of a wireless link depends upon the quality of the link and the amount of interference. Several measurement studies have been done in literature to study the link quality in 802.11-based wireless networks. Similarly, several works have looked at the issue of interference in such networks in addition to link quality. Studies have investigated the impact of carrier sensing. One approach developed a measurement-based methodology to characterize link interference in 802.11 networks. This work pointed out that interference between links is not “binary” in practice unlike assumed in many analytical work that use simple graph-based conflict models. It has been shown that pairwise interference modeling is often not accurate and multiple interferers must be accounted for.

Another approach proposed a model to use the measured signal strength between pair of nodes, thus requiring only O(N) experiments, to characterize link quality as well as to create a physical layer model for deferral and collision.

There have been several studies in characterizing and evaluating the capacity of wireless networks using analytical modeling. The capacity in this context is the network capacity for multihop flows. Prominent examples include asymptotic capacity and capacity modeling using concepts from network flow maximization. They all use various abstract link interference models from pairwise models, such as protocol model, to more general models, such as physical interference model, based on SINR (signal to interference plus noise ratio). Typically, simple path loss models are assumed for RF propagation. Even with the most realistic models, instantiating such models in a real network is hard without actual measurements, as models come with several unknown parameters. The papers in this category are interested in performance bounds and typically do not use any MAC protocol model except slotted TDMA scheduling.

Finally, several papers have considered analytical modeling of 802.11 MAC protocol in multihop context to determine throughput and fairness characteristics. For example a single hop analytical model has been extended to a multi-hop 802.11 network to derive the per-flow throughput in a multi-hop network. Another analytical model proposed to determine the end-to-end throughput capacity of a path carrying a flow in a multi-hop 802.11 network. However, all these works still use simple pairwise (or protocol) model of interference. The advantage of using such pairwise model is that a node that is not an interferer in isolation cannot become an interferer in conjunction with other nodes. However, in SINR-based physical interference model, this is a possibility.

Accordingly, there is a need for a practical, measurement-based method that captures the effect of interference in 802.11-based mesh networks and for any given link in the presence of any given number of interferers in a deployed network.

### SUMMARY OF THE INVENTION

A method according to the invention includes determining a PHY layer model for a single interferer in an 802.11 wireless network responsive to an input of measured pair wise of at least one of a delivery ratio and received signal strength RSSI values in the 802.11 wireless network; ascertaining a deferral probability for a given node in the network in the presence of multiple interferers in a MAC layer model of the 802.11 network responsive to the determining step in the PHY layer model; and deriving from the ascertaining step at least one of sending capacity in the presence of multiple interferers, packet collision probability in the presence of multiple interferers and available capacity in a given link for a corresponding link delivery ratio.

In accordance with another aspect of the invention, there is provided a method that includes creating a PHY layer model in an 802.11 wireless network of deferral which is whether enough interference power is received to indicate a wireless carrier is busy and of packet capture whether a signal to interference noise ratio SINR is high enough for a packet to be received, the deferral and packet capture being responsive to measurements in a one time profiling done for each interface type; seeding the PHY layer model by link-wise measurement of received signal strength RSS values in a target mesh network, and feeding the PHY layer model to a MAC layer model in the network enabling the MAC layer model amenable to numeric solution evaluating how long the MAC layer stays in appropriate states that contribute to capacity.

### BRIEF DESCRIPTION OF DRAWINGS

These and other advantages of the invention will be apparent to those of ordinary skill in the art by reference to the following detailed description and the accompanying drawings.

FIG. 1 is a block diagram of an exemplary overview of the measurement-based method that accounts for any number of interferers and determines link capacity in 802.11-based wireless networks, in accordance with the invention.

FIG. 2 is a block diagram of a further exemplary overview of the measurement-based method that accounts for any number of interferers and determines link capacity in 802.11-based wireless networks, in accordance with the invention.

FIG. 3 is a state transition diagram for 802.11-based network on the sender-side.

FIG. 4 is a block diagram of a yet further exemplary overview of the measurement-based method that accounts for any number of interferers and determines link capacity in 802.11 wireless based networks, in accordance with the invention.

### DETAILED DESCRIPTION

Characterizing interference is critical to understanding the performance of a wireless network. The invention teaches a practical, measurement-based model that captures the effect of interference in 802.11-based wireless LAN or mesh networks. The goal is to model capacity of any given link in the presence of any given number of interferers in a deployed network, carrying any specified amount of offered load. Central to the inventive approach approach is a MAC-layer model for 802.11 that is fed by PHY-layer models for deferral and packet capture behaviors, which in turn are profiled based on measurements. The target network to be evaluated needs only O(N) measurement steps to gather metrics for individual links that seed the models. Two solution approaches are provided: 1) one based on direct simulation (slow, but accurate) and the other 2) based on analytical methods (faster, but approximate).

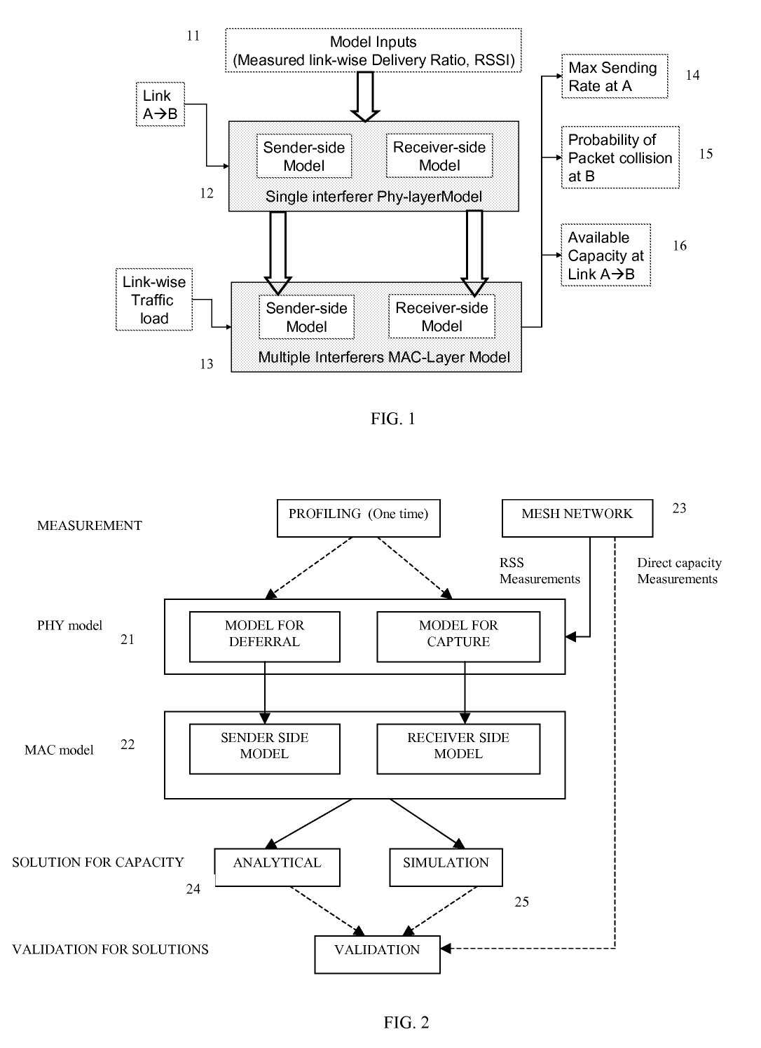

Referring now to FIG. 1, there is shown exemplary overview of the measurement-based method that accounts for any number of interferers and determines link capacity in 802.11-based wireless networks, in accordance with the invention. See a further exemplary overview in FIG. 4, in accordance with the invention. The inventive method takes as input pair wise delivery ratio and/or RSSI (received signal strength) values 11, 41. This input requires O(N) measurements where N is the number of nodes. We create two models based on this input- the sender-side that captures the contention among senders and determines the sending capacity; the receiver-side that captures the interference and determined the probability of packet collision. The measurement-based model is more accurate as it is difficult to model the physical layer radio propagation.

The first part consists of creating the model for single interferer 12, 42. This model is constructed based on statistics about how much a node defers for a given RSSI value (sender-side) and the packet collision probability for a given RSSI value (receiver-side). The second part of the model takes an analytical approach. In this approach, based on the 802.11 MAC layer model, we derive the deferral probability for a given node in the presence of multiple interferers 13, 43. Solving this model represented by a set of linear equations provides the sending capacity. Similarly, we derive the receiver-side packet collision probability in presence of multiple interferers.

The inventive technique can provide three types of information: A) the sending capacity in presence of multiple interferers 14, 44, b) the packet collision probability in presence of multiple interferers 15, 45 and C) the available capacity for a given link if the link delivery ratio is known 16, 46. The inventive approach accommodates the effect of traffic load in determining the sending capacity and probability of packet collision. Attaining the model for multiple interferers in the Mac layer interaction permits root cause analysis of WLAN network 47, deployment planning of WLAN mesh network 48, power channel and allocation.

For WLAN mesh network 49 and session admission control voice-over-internet-protocol (VOIP) 410.

### Modeling Approach

A. Problem Formulation

We are interested in determining the capacity of a specific link in a 802.11 network given the offered load on a set of other links. More formally, assume an N node network with all nodes in the same channel and using the same PHY-layer bit rate. Assume a subnetwork with n+1 nodes consisting of a set of n transmitters, Z={z₁ . . . zₙ}, and a receiver, x. We are interested in evaluating the throughput capacity of the link from one of the transmitters (say, zᵢ) to the receiver x. In this case, zᵢ acts as sender and all nodes in Z−{zᵢ} act as interferers. All other nodes in the network outside the subnetwork above are assumed silent. We will use the notation C_{receiver}^{sender} (set of interferers) to designate throughput capacity of the link. Thus, we are interested in determining the throughput capacity, Cₓ^{z}^{ᵢ}(Z−{zᵢ}), of the link zᵢ to x, given the offered load lᵢ on each transmitter in Z.

The capacity of an 802.11 wireless link depends on the following factors—(i) channel quality that determines the bit error rate for a given PHY-layer bit rate (governed by modulation used); this translates to packet loss rate from the point of view of an upper layer protocol; (ii) interference from other transmissions in the network that influences how the 802.11 MAC protocol behaves at the sender side and whether packet collisions occur at the receiver side. Our goal is to develop a measurement based model that captures the “time averaged” behavior of the physical and MAC layers in 802.11, and thereby predicts the throughput capacity of a wireless link in presence of any number of interferers and with any given traffic load matrix. Note that given the time varying nature of wireless channels, “instantaneous” behaviors are very hard to model using measurement based approaches.

B. Overview of Approach

A high level block diagram of a further exemplary overview of the measurement-based method that accounts for any number of interferers and determines link capacity in 802.11-based wireless networks, in accordance with the invention is shown in FIG. 2. The centerpiece is a MAC-layer model 22 of 802.11 that is fed by a PHY-layer model 21. The PHY layer model models two behaviors that MAC depends on: (i) deferral, whether enough interference power is received to indicate carrier busy, (ii) packet capture, whether the SINR is high enough such that packet is received correctly. These dependencies are modeled via measurements in a one-time profiling experiment. The profiling is done for each interface card model or type, and can be reused.

These models are seeded by link-wise measurement of RSS (received signal strength) values in the target wireless LAN or mesh network 23. The RSS values can be measured by having each node taking turn and sending a set of broadcast packets. For a given broadcasting sender, rest of the nodes record RSS. For an N node network, the measurement requires O(N) measurement steps and provides the metrics for all the N(N−1) links. This seeding now makes the MAC-layer model amenable to numeric solution. The solution evaluates how long the model stays in appropriate states that contribute to capacity. Two solution approaches are possible—(a) analytical method 24 and (b) simulation 25. The analytical method translates the model to a set of coupled equations that are solved using numerical methods. The method uses certain (reasonable) assumptions to make it analytically tractable, which also makes the solutions approximate. Simulation, on the other hand, accurately follows the MAC-layer model, but results in much slower computation.

### Modeling 802.11 Behavior

We begin by stating an assumption that we have made in most of the application for modeling convenience. We assume that 802.11 is using only broadcasts, i.e., implementing unicast using broadcasts. Broadcast does not have link-layer ACKs, and exponential backoffs. This simplifies the approach to some extent. It has also been shown that interference between links carrying unicast traffic can be well predicted by the amount of interference computed when they carry broadcast traffic. Note that we are merely using this simplification for brevity. The modeling approach is general and can be extended to unicasts.

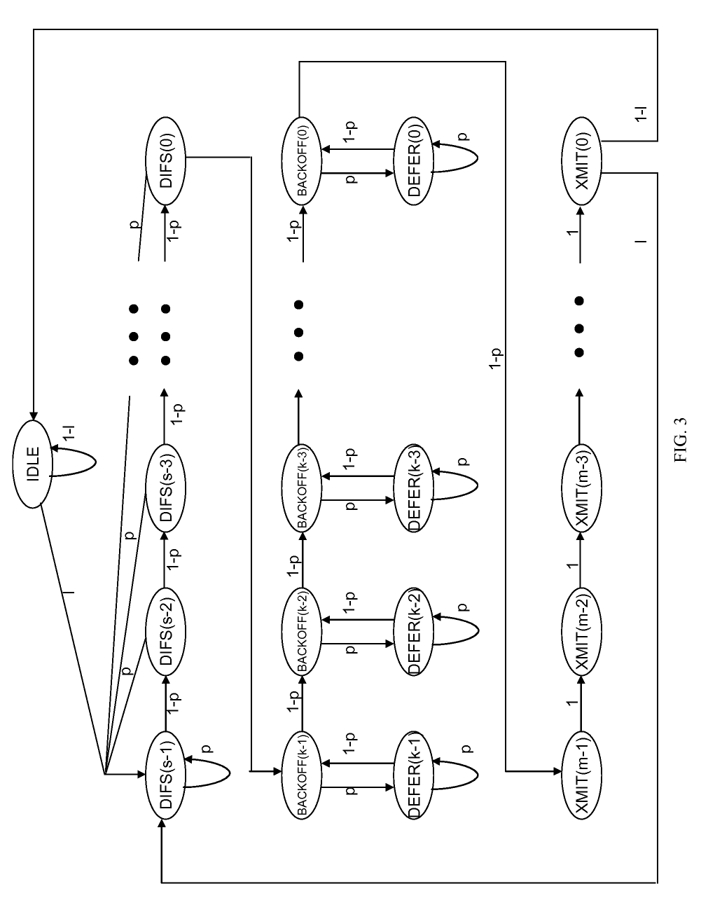

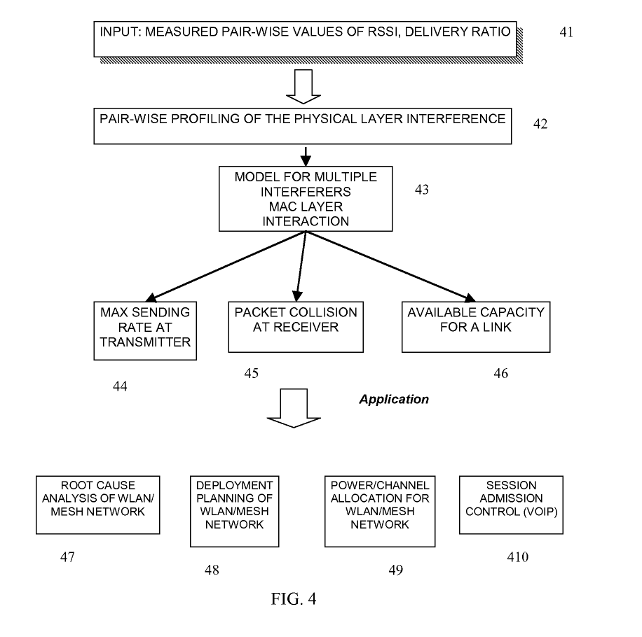

We present the behavior of 802.11 MAC protocol from the point of view of a single node as a discrete time Markov chain. See the state transition diagram of FIG. 3. For this we discretize time, albeit somewhat artificially, into slots. These slots are different from 802.11 slots. The size of the slots is chosen such that they are small enough that the protocol state does not change within a slot, and the duration of any protocol state has only integer number of slots.

There are five possible states—IDLE, DIFS, BACKOFF, DEFER or XMIT. Each of these states consists of many sub-states denoting the number of slots they span. We need multiple sub-states because the sub-states are not independent of each other. When the node is not attempting any transmission, it is in the IDLE state. When in IDLE state, in every slot the node checks if it has any packet to transmit. This depends on the offered load lᵢ for the node zᵢ, and represents the probability to begin packet transmission. When traffic is backlogged, a node never enters the IDLE state. When, the node has a packet to transmit, it moves to the DIFS state (this is an inter-frame spacing defined in the protocol standard), which has s sub-states, where s is the number of slots a node has to be in DIFS state. If the node senses the channel busy during this period, it goes back to the beginning of DIFS, i.e., DIFS(s-1). The probability of channel being busy is given as p, also called the probability of deferral. This probability is a PHY-layer aspect and depends on the aggregate power from other nodes reaching this node. This in turn depends on the current state of the other nodes.

After successful completion of the DIFS period, i.e., upon reaching DIFS(0), the node chooses a random BACKOFF period, spanning k slots, where 0<k<CWₘᵢₙ, and moves to the sub-state BACKOFF(k-1). It then counts down the BACKOFF timer, and thus progressing from one BACKOFF sub-state to the other, but only if the channel is sensed idle. If the channel is sensed busy (again with probability p), the node goes into the DEFER state, where it freezes the BACKOFF timer. It remains in the DEFER state as long as the channel is busy. The node goes back to the BACKOFF state with the probability of the channel being idle (probability 1-p). Having counted down the BACKOFF timer to 0, the node starts transmitting the packet. This brings it to the XMIT state. Assume that the XMIT state stays for m slots depending on the PHY-layer bit rate and packet size. After completing the packet transmission, the node goes back to IDLE state if there is no other packet to transmit, or prepares for the next transmission with another DIFS.

One key approximation made in this model is that the deferral probability p is assumed to be constant during the evolution of the Markov process.1 This probability depends on the activity of the other nodes. Thus, the state transitions of other nodes are closely coupled. When we solve this model using a direct simulation (i.e., simulating the Markov chain) we do not make such constant p assumption and use the value p as computed at that slot. When we solve the chain using the analytical approach in the following section, p is the “average” deferral probability. This averaging works due to an inherent approximation used in the analytical solution approach to be described momentarily.

So far we have described only the transmitter side. On the receive side, the model is simpler. A node not in XMIT state can receive a complete packet slot by slot, assuming it receives it error-free in each slot. The probability of error-free reception of a complete packet (packet capture probability) depends on the bit-error rate (BER) in the PHY-layer which in turn depends on the SINR (signal to interference plus noise ratio). Ignoring error correction coding, the probability of packet capture is (1-BER)^{b}, where b is the packet size in bits. Thus, packet capture probability depends on SINR.

Both probabilities for deferral and packet capture are functions of one or more powers (signal, interference and noise). They are input to the model. We will determine these functions via profiling experiments and seed them by power measurements in the target network.

### Analytical Approach

Due to the coupling of the Markov chains of individual nodes as mentioned before, solving an equivalent Markov chain for the network as a whole is computationally hard. This is because of a state-space explosion, as all possible combinations of states for all nodes can be a potential state in the combined Markov chain. Direct simulation of the Markov chain is of course viable, and we will indeed use simulation as our one solution approach. However, as we will see later in our evaluation, simulations are slow. In this section, we develop an alternative solution approach using analytical modeling.

The analytical approach makes an approximation that the current state of the process does not depend on the previous state. This is similar to the approximation made for modeling tractability. With this approximation, the process can move to any of the above five states (ignoring sub-states for now) based on a constant probability at the end of a slot. These probabilities depend only on the average behavior of network nodes. Much of the work in the modeling here is formulating these probabilities. Once formulated, one can write up the steady state equations, one for each of the n transmitters, and then solve these equations to derive the fraction of time a node is in the XMIT state, thus giving the transmission capacity of this node.

On the receiver side, the approach is similar. Instead of bit-error rate, packet capture probability is used directly. This again depends on the activities of other nodes. Any receiver x in a slot receives correctly a packet on the air (only one slot worth) from a designated sender zᵢ with this probability. This contributes to the throughput capacity of the link from zᵢ to x.

Going forward, we start by assuming a saturated traffic regime. This means that all transmitters are always backlogged. This saturated traffic assumption is useful as it eliminates traffic load from the model and eliminates the IDLE state. We show later that the analytical approach is easily amenable to consideration of non-saturated traffic.

### A. Baseline Notations

Consider an observation interval of Γ slots, where Γ→∞. In each slot, a subset of the n transmitters in Z={z₁, . . . , zₙ} may attempt transmission. The set Z does not change during the duration of Γ slots. Let us first define the following notations:

Iᵢ is the set of time slots in which node zᵢ is idle. This is when node zᵢ is in the IDLE, DIFS or BACKOFF states.

Dᵢ is the set of time slots in which node zᵢ defers because it can sense the transmission of other nodes. This is the period where zᵢ freezes its backoff timer and goes into the DEFER state.

Tᵢ is the set of time slots in which node zᵢ transmits, denoted by the XMIT state.

iᵢ=|Iᵢ|/|Γ|, is the fraction of time node zᵢ is idle.

dᵢ=|Dᵢ|/|Γ|, is the fraction of time node zᵢ defers.

cᵢ=|Tᵢ|/|Γ|, is the fraction of time node zᵢ transmits. So, cᵢ is the normalized transmission capacity of node zᵢ.

c_{Y}, where Y⊂Z, is the fraction of time all nodes in set Y transmit. Thus,

$${c}_{Y} = \vert {⋂}_{{z}_{i} ∈ Y} {T}_{i} \vert / \vert T \vert . \qquad ( 1 )$$

t_{Y}, where Y⊂Z, is the traction of time when all nodes in Y transmit, while none of the other nodes (in Z-Y) transmit. Thus,

$${t}_{Y} = \vert {⋂}_{{z}_{i} ∈ Y} {T}_{i} - {⋃}_{{z}_{j} ∈ Z - Y} {T}_{j} \vert / \vert T \vert . \qquad ( 2 )$$

If Y consists of a single node, say zᵢ, we abuse the notation slightly to represent it as tᵢ to represent t_{{z}_{ᵢ}_{}}·tᵢ is thus the fraction of time node zᵢ transmits, and no other node in Z transmits.

pᵢ^{Y}, where Y⊂Z-{zᵢ}, is the conditional probability that when all nodes in Y transmit in a slot, zᵢ defers its transmission because it senses the channel to be busy. When Y has just one node, say zⱼ, then we again abuse the notation to represent it as pᵢ^{j}.

Interference affects link capacity by limiting the transmission rate at the sender side and causing packet collisions at the receiver side. We denote these aspects as “sender-side interference” and “receiver-side interference” respectively and model them separately.

B. Sender-Side Interference

To compute the impact of sender-side interference, we determine the transmission capacity (cᵢ) of each node in Z. Using the notations defined above, Iᵢ, Dᵢ and Tᵢ are disjoint sets. Also, every slot is at least in one of these three sets for every node. Thus, Iᵢ∪Dᵢ∪Tᵢ=T. This implies that

iᵢ+dᵢ+cᵢ=1. (3)

In the saturated traffic scenario, a node is idle only during DIFS or backoff period. This happens for every packet transmission. DIFS is constant; however the backoff period is random, uniformly chosen between 0 and CWₘᵢₙ slots of, say, size σ for broadcast packets.2 Knowledge of packet size and channel bit rate can now provide an expression for the ratio (α) of the idle and transmit times, on average:

$$α = \frac{{i}_{i}}{{c}_{i}} = \frac{DIFS + \frac{1}{2} {CW}_{min} σ}{( P + H ) / W} . \qquad ( 4 )$$

Here, P is the packet payload size, H is the size of the headers, W is the channel bit rate. Using the standard values of DIFS, slot sizes, CWₘᵢₙ and various headers, we determine α at the lowest bit rate for 802.11b (1 Mbps) for 1400 byte packet payloads. This comes to 0.03 for 802.11b.

Equation (3) can now be re-written as

(1+α)cᵢ+dᵢ=1. (5)

In the above expression, dᵢ is the fraction of time slots node zᵢ defers due to the transmission of other nodes. In each slot, there can be a set of nodes (say, Y) that transmit. For each slot the conditional probability that zᵢ defers to Y, given that all nodes in Y are transmitting is pᵢ^{Y}. We can now add up the deferral probabilities in each slot for all possible combinations of Y to obtain dᵢ. Note that t_{Y} is the fraction of time slots in which all nodes in Y transmit. Thus,

$${d}_{i} = {\sum }_{Y ∈ 𝒫 ( Z - \{ {z}_{i} \} )} {p}_{i}^{Y} {t}_{Y} , \qquad ( 6 )$$

where P(S) is the power set of set S. This leaves us with pᵢ^{Y} and t_{Y} to be determined for each possible Y, such that Y⊂Z−{zᵢ}.

1) Determining pᵢ^{Y}: Recall that pᵢ^{Y} is the conditional probability that zᵢ defers when all nodes in Y are transmitting. Here, we need to model the MAC protocol's interaction with the physical layer, as this probability should depend on the aggregate signal powers received at zᵢ from all nodes in Y. To make further progress, the relationship between the deferral probability and received signal strengths must be modeled. Since this is intimately related to the actual radio interface used, we use a measurement driven strategy here.

The first step is to create an empirical relationship for the probability of deferral between two nodes based on received signal strengths. We express this relationship as a function ƒ(•), such that pᵢ^{j}=ƒ(rssᵢ^{j}), where rssᵢ^{j} denotes the average of measured signal strength value of packets transmitted from zⱼ and received at zᵢ. We determine function ƒ(•) from a prior profiling study. Note that this function models interface properties rather than wireless propagation in an actual deployment. Thus, such prior profiling study is possible. However, in our experience, individual cards do not need to be profiled in this fashion, only card types or card models need to be profiled. These profiles can be reused from a library for different modeling applications. This is in contrast to a similar profiling approach used in by others, where individual cards are profiled. Note that the inventive approach is general and is not restricted to a homogenous system using identical cards. However, for brevity, our experimental results show results from a homogeneous deployment.

Once the function ƒ(•) describing the relationship between the deferral probability and signal strengths is determined, pᵢ^{Y} can be expressed as in the following.

$${p}_{i}^{Y} = f ( {\sum }_{{z}_{j} ∈ Y} {rss}_{i}^{j} ) . \qquad ( 7 )$$

This is true since the deferral only depends on the aggregate signal strengths. Now, if the measurements of the pairwise rssᵢ^{j} values in the deployed network are available, pᵢ^{Y} can be determined for any Y. Note that measuring all rssᵢ^{j} values requires O(N) measurement steps.

2) Determining t_{Y}: Recall from equation (2) that t_{Y} is the fraction of time all nodes in set Y transmit, and all nodes in the complement set Z-Y remain silent. c_{Y} on the other hand is the fraction of time nodes in Y transmit, but nodes in set Z-Y may or may not transmit. We determine t_{Y} in terms of c_{Y} using equations (1) and (2). From these equations,

$${t}_{Y} = {c}_{Y} - \vert ( {⋂}_{{z}_{i} ∈ Y} {T}_{i} ) ⋂ ( {⋃}_{{z}_{j} ∈ Z - Y} {T}_{j} ) \vert / \vert T \vert .$$

The second term on the right hand side can be expanded using the principle of inclusion and exclusion of set theory, which after evaluation reduces to the following

$${t}_{Y} = {\sum }_{X ∈ 𝒫 ( Z - Y )} {( - 1 )}^{\vert X \vert} {c}_{Y ⋃ X} , \qquad ( 8 )$$

where [symbol] (S) denotes the power set of S.

We still need to determine c_{Y}, which is the fraction of time nodes in Y transmit together. Nodes in Y transmit together when every node in Y does not defer for every other node in Y. Thus, c_{Y} can be expressed as,

$${c}_{Y} = {\prod }_{{z}_{i} ∈ Y} ( 1 - {p}_{i}^{Y - {z}_{i}} ) {c}_{i} . \qquad ( 9 )$$

Equations (6), (7), (8) and (9) can be used to obtain dᵢ and then used in equation (5) to write an equation consisting of cᵢ's and rssᵢ^{j} as the only unknowns. The rss values come from the measurements, leaving only cᵢ's as unknowns. Now, for each value of the subscript i (i.e., a transmitter) one such equation is obtained, giving n equations for n transmitters. We solve these equations to derive the normalized transmit capacity cᵢ for each transmitter.

C. Receiver-Side Interference

So far, we have modeled transmission capacity of the transmitter. We now need to model receiver-side interference to determine how much of the transmission capacity actually translates into throughput. Receiver-side interference causes collisions. Thus, if the sender and multiple interferers transmit concurrently, we need to model the probability of packet capture at the receiver. As discussed before, this is done by deriving a relationship between the capture probability and the SINR. This is done in the same fashion as in the case of deferral probabilities in the previous section. Exactly as before, we relate packet capture probabilities to SINR via a function g(•) that is profiled via independent measurements.

Define delivery ratio drᵢ^{j} from zⱼ to zᵢ as the fraction of packets received by zᵢ that are transmitted by zⱼ in the absence of any other interfering transmitter. Let us define drᵢ^{j}(Y) as the delivery ratio from zⱼ to zᵢ in presence of the set of interferers Y. Our first task is to model drᵢ^{j} as drᵢ^{j}=g(rssᵢ^{j}/noise). This simply relates packet capture probability to SNR, the ratio of the received signal strength and noise. Here rssᵢ^{j} denotes the average signal strength of packets received from zⱼ to zᵢ in absence of interference.

Once the function g(•) has been modeled, drᵢ^{j}(Y) can be expressed as follows:

drᵢ^{j}(Y)=g(SINRᵢ^{j}(Y)), (10)

where,

$${SINR}_{i}^{j} ( Y ) = \frac{{rssi}_{i}^{j}}{{\sum }_{k ∈ Y} {rss}_{i}^{k} + noise} . \qquad ( 11 )$$

As in the case of equation (7), the above equation also requires only pairwise measured rss values in the deployed network.

D. Capacity of Link

Now, we combine the sender and receiver-side interferences to determine the capacity of the link. Let us choose zᵢ as the designated sender from the set Z, and let x be the receiver. All the other transmitters are interferers for this link. Assume that only a subset Y of the set of interferers Z-{zᵢ} is active in a slot and the others are silent (due to deferral or idleness). By definition, t_{Y} is the fraction of slots with this property. t_{{z}_{ᵢ}_{}∪Y} is thus the fraction of time the sender zᵢ transmits along with some subset of the interferers. This models the packets that are transmitted from the sender notwithstanding sender-side interference. This quantity multiplied by drₓⁱ(Y) models how many of them are captured at the receiver x notwithstanding receiver-side interference.

Thus, the overall link capacity (in bits per sec) from the sender zᵢ to receiver x in the presence of a set of interferers Z-{zᵢ} is given by,

$${C}_{x}^{{z}_{i}} ( Z - \{ {z}_{i} \} ) = \frac{P}{P + H} \times W \times {\sum }_{Y ∈ 𝒫 ( Z - \{ {z}_{i} \} )} {dr}_{x}^{Y} \times {t}_{\{ {z}_{i} \} ⋃ Y} . \qquad ( 12 )$$

The first term models the header overhead and the second term specifies the channel bit rate. The third term models the above argument. Consideration of the power set is necessary as any set of interferers can be active in a slot. The summation over all these possibilities works as they are all mutually exclusive.

Previously herein, we indicated how to compute cᵢ's. The t_{Y}'s can be determined using equations (8) and (9). The dr's come from the measurement-based modeling directly. Thus, the link capacity C can be determined using equation (12). The approach of solving equations is described in the following section.

### Solving Equations

The first and hardest step in the solution is solving for the sender-side model as described previously. This generates a set of non-linear equations involving cᵢ's as the only unknowns, which need to be solved to determine numeric values for cᵢ's. This is the computationally intensive part of the model solution. Once cᵢ's are determined, the rest of the steps needed to determine the capacity Cₓ^{z}^{ᵢ}(Z−{zᵢ}) is relatively straightforward, as they need only value substitutions. Thus, for brevity, we only discuss the sender-side solution (determining cᵢ's).

There are n equations, one for each transmitter zᵢ. The number of terms in each equation can be exponential in n involving all possible combinations of cᵢ's in a product form, i.e., terms like cᵢ, cᵢcⱼ, cᵢcⱼcₖ, etc., going upto c₁c₂ . . . cₙ. In our validation work, we have often had opportunities to simplify the equations that reduces the number of terms involved and thus the computation time. Two types of simplifications are possible (see below). This is easily understood by looking at equation (6).

pᵢ^{Y}=0: This means that the node zᵢ does not defer for the nodes in Y. In such cases, the term pᵢ^{Y}t_{Y} becomes 0.

pⱼ^{k}=1and pₖ^{j}=1: This means that node zₖ and zⱼ can hear each other perfectly, and their transmissions never overlap each other (t_{{z}_{ⱼ}_{,Z}_{ₖ}_{}}=0). In such a case, the term pᵢ^{{z}^{ⱼ}^{,Z}^{ₖ}^{}}t_{{z}_{ⱼ}_{,Z}_{ₖ}_{}} becomes 0.

Also, these terms do not need to be perfectly 0 or 1 to be eliminated. Terms close enough to 0 or 1 can be approximated as 0 or 1. In our testbed, we found many such opportunities to reduce the number of terms in each equation.

### A. EXAMPLES

### Two and Three Transmitters

To get a better understanding about these equations, we will consider two sets of examples below—one with 2 transmitters (z₁ and z₂), and other with 3 transmitters (z₁, z₂ and z₃). For notational convenience, we will write t_{{z}_{ᵢ}_{,Z}_{ⱼ}_{}} as t_{i,j}. Similarly, we write pᵢ^{{z}^{ⱼ}^{,Z}^{ₖ}^{}} as pᵢ^{j,k}.

The equations for two transmitters case are:

(1+α)c₁+p₁²c₂=1

(1+α)c₂+p₂¹c₁=1 (13)

The solutions are

$${c}_{1} = \frac{( 1 + α ) - {p}_{1}^{2}}{{( 1 + α )}^{2} - {p}_{1}^{2} {p}_{2}^{1}} , {c}_{2} = \frac{( 1 + α ) - {p}_{2}^{1}}{{( 1 + α )}^{2} - {p}_{2}^{1} {p}_{1}^{2}} .$$

Let us consider two special cases, one in which both nodes can hear each other perfectly (p₁²=p₂¹=1), and another, where neither can hear the other other (p₁²=p₂¹=0). The solution for 802.11b (α=0.03) is (c₁=0.49, c₂=0.49) and (c₁=0.97, c₂=0.97) respectively.

The three transmitter case is a little more involved. As an example, the equation for a single node (z₁) is

(1+α)c₁+p₁²t₂+p₁³t₃+p₁^{2,3}t_{2,3}=1, (14)

where

t₂=c₂−c_{2,3}, t₃=c₃−c_{2,3}, t_{2,3}=c_{2,3},

c_{2,3}=(1−p₂³)(1−p₃²)c₂c₃, p₁^{2,3}=ƒ(rss₁²+rss₁³).

### Extensions

Now, we will pay our attention to the two simplifying assumptions we have used so far. The first is related to the assumption of saturated traffic in the analytical solution approach. The second is the consideration of broadcast transmission only. We will now discuss how to handle these issues.

A. Non-Backlogged Interferers

To model non-saturated conditions, we will need to account for the IDLE state in FIG. 2. Assume first that there are only two transmitters z₀ and z₁. Assume that z₁, the interferer, is not backlogged and has packets to transmit only l fraction of times. In other words, the normalized offered load at z₁ is l. Let us now represent the capacity of link z₀ to x in presence of such an unsaturated interferer as Cₓ^{z}^{₀}(z₁,l), with a little abuse of notation.3 We show how Cₓ^{z}^{₀}(z₁,l) depends on Cₓ^{z}^{₀}(z₁), the capacity in presence of a saturated interferer.

If l is greater than c₁, z₁'s transmission capacity, the case is similar to the saturated interferer because node z must be always backlogged to satisfy its offered load. If l is less than c₁, node z₁'s demand is satisfied, and z₀ can use the silent period of z₁ for transmitting packets. The fraction l/c₁, thus, can be seen as the fraction of time the two transmitters behave as if they are in backlogged conditions. The remaining fraction of time, 1−l/c₁ is monopolized by z₀'s transmissions. Thus,

$${C}_{x}^{{z}_{0}} ( {z}_{1} , l ) = \{ \begin{matrix}[ ( 1 - \frac{l}{{c}_{1}} ) {C}_{x}^{{z}_{0}} ( Φ ) ] + [ \frac{l}{{c}_{1}} {C}_{x}^{{z}_{0}} ( {z}_{1} ) ] , & l < {c}_{1} \\ {C}_{x}^{{z}_{0}} ( {z}_{1} ) , & otherwise .\end{matrix} \qquad ( 15 )$$

We can extend this approach for solving for the non-backlogged interferer to multiple such interferers. Assume, node x is the receiver, node z₀ is the sender, and a set of nodes Z={z₁, . . . , zₙ} are the interfering nodes. Assume, the nodes in set Z have normalized offered loads L={l₁, . . . , lₙ}, respectively. Let us consider the interferer, zᵢ, with the smallest load, such that its demand can be satisfied. The fraction lᵢ/cᵢ can be seen as the fraction of time when all the nodes have backlogged traffic. Thus,

$${C}_{x}^{{z}_{0}} ( Z , L ) = [ ( 1 - \frac{{l}_{i}}{{c}_{i}} ) \times {C}_{x}^{{z}_{0}} ( Z - \{ {z}_{i} \} , {L}^{′} ) ] + [ \frac{{l}_{i}}{{c}_{i}} \times {C}_{x}^{{z}_{0}} ( Z ) ] . \qquad ( 16 )$$

where L′ is the residual offered load vector after the load in the fraction of time with saturated conditions with zᵢ has been satisfied. For zⱼ, current residual load is l′ⱼ.

$${l}_{j}^{′} = {l}_{j} - \frac{{l}_{i}}{{c}_{i}} \times {c}_{j} . \qquad ( 17 )$$

3Cₓ^{z}^{₀}({z₁},1.0) is written as Cₓ^{z}^{₀}(z₁).

The above equation can be further reduced by considering the next node with the smallest demand and so on, until we are left with backlogged nodes only.

### B. Modeling Unicast

Unicast transmission in 802.11 provides reliability using retransmissions when the packet is not delivered successfully, and an ACK is not received from the receiver. When retransmitting a packet, the backoff window is doubled. This is done repeatedly until the ACK is received, or the retry limit has been exceeded. The broadcast model presented in FIG. 3 can be easily extended to handle ACKs and increased backoffs for each retransmission. This would require an extra transition from the XMIT(0) state to the BACKOFF(k′) state with a probability equal to collision probability (modeled by 1−dr) where k′ is the new backoff window, 0<k′<2CWₘᵢₙ.

Let us consider a scenario with sender z₀, receiver x, and interferers Z as before. The analytical approach presented previously needs following modifications to solve the unicast model.

Idle time computation: Due to retransmissions, and multiple backoffs for the transmission of a single packet, the ratio between normalized idle times (iᵢ) and transmit times (cᵢ) does not remain a constant. We can compute idle time by considering all possible subsets Y of the interferer set Z and the collision probability with each of these subsets, when they are active. For each Y, the backoff time evolution is a geometric process with the collision probability as parameter. Thus,

$${i}_{i} = {\sum }_{Y ∈ 𝒫 ( Z )} \frac{DIFS + SIFS + bo ( Y )}{( P + H ) / W} {t}_{\{ {z}_{0} \} ⋃ Y} , \qquad ( 18 )$$

where, bo(Y) is the average backoff time spent for transmitting a packet (including retransmissions) from z₀ to x when a subset of interferers Y is active:

$$bo ( Y ) = {\sum }_{k = 0}^{m} {( 1 - {dr}_{x}^{Y} )}^{k} {2}^{k - 1} {CW}_{min} σ . \qquad ( 19 )$$

Here, m denotes the retransmission limit for a packet.

Consideration of ACK: We keep equation (3) unchanged by considering ACK transmissions as part of a sender's transmission. Thus, in any XMIT slot, a node may be transmitting data, or receiving ACK. ACK packets are small and their impact in causing interference is also small relative to data packets. Also, ACK is transmitted only once per successful packet transmission, while the packet may be retransmitted. Thus, for a single packet, the proportion of time slots occupied by ACK is very small compared to the time slots occupied by data. In the XMIT slots, ACK may impact the deferral probability, and the probability of collision by causing DATA-ACK, or ACK-ACK collisions. Both these probabilities may still be modeled by attributing a small (appropriately computed based on sizes) probability to a XMIT slot being occupied by an ACK transmission. Another simplified model could simply ignore the effect of ACK transmissions in causing interference.

With the above modifications, the link capacity can be computed as in the case of broadcast following the same steps. Note that once the slots of the sender's transmission has been identified, the unicast capacity for those slots is identical to the broadcast capacity. This is because if the probability of packet capture is fixed, it does not matter whether a packet is being transmitted or retransmitted. The throughput of the link will be the same in both cases, as throughput only depends on the number of unique packets successfully received.

Summarizing, modeling unicast requires modifying the model for idle time computation, and considering the probability of collision and deferral for ACK packets. Even though the inclusion of these in the model makes the model more accurate, it adds an extra complexity for the analytical and simulation-based approaches. The impact of these factors are small because ACK packets are small in general, and the extra idle time is much less than the packet transmission time for large packets. Also, as we argued above, retransmissions do not impact the capacity computation for a link except for the extra idle time. Given this, it is worth debating whether there is much benefit at all from modeling the more complex unicast. It has been shown that the interference between unicast transmissions can be well estimated by estimating the interference between broadcast transmissions.

The inventive method addresses the challenging problem of modeling link capacities in a real, deployed 802.11 network. This is a departure from the prior methods of analytical or simulation-based modeling that often make unrealistic assumptions. The inventive method is based on the realistic physical interference model that drives a discrete time Markov chain-based model of 802.11 behavior. The physical interference model is profiled using measurements and is seeded again by measurements on the target network to be evaluated. The methods we proposed are practical—(i) The profiled measurements can be kept in a library and reused. (ii) The measurements on the target network are simple and take O(N) steps. (iii) The analytical solution time is of “sub-second” scale opening up a lot of applications that use course-grain decision making, such as overlay MAC scheduling, routing, admission control and channel assignment.

While we have used a single channel, single packet size, single data rate and single interface card model in this application, this is not a limitation. Profiling can be done for all these parameters separately. Some additional modeling can indeed help in profiling effort. For example, profiling for one size can possibly be extrapolated for other sizes. In principle, the modeling approach is able to handle heterogenous systems, where different nodes use different parameters, so long as cards with all such parameter settings have been profiled for. The harder problem is handling dynamically changing parameters, for example, auto rate control in 802.11. In this case, the rate control algorithm must be modeled as a part of our approach. Also, our approach is general enough such that extensions of 802.11 (e.g., 802.11e) can be modeled using a similar Markov model, though more states probably will make the solutions more compute intensive.

Again, the inventive approach is based on using O(N) measurements—minimum required to obtain such a model as opposed to O(N̂2) measurements. The invention provides the following basic advantages in WLAN/Mesh network resource management. The invention can be used to figure out root causes of overload or packet collision at any access points. The invention can be used for efficient power and channel allocation to improve performance. The inventive method can be used for call admission of traffic with QoS constraints (VoIP, Media) and can be used for capacity planning—where to deploy APs,

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations, which although not explicitly shown or described herein, embody the principles of the invention and are within their spirit and scope.

What is claimed is:

1. A method comprising the steps of:
determining a PHY layer model for a single interferer in an 802.11 wireless network responsive to an input of measured pair wise of at least one of a delivery ratio and received signal strength RSSI values in the 802.11 wireless network;
ascertaining a deferral probability for a given node in the network in the presence of multiple interferers in a MAC layer model of the 802.11 network responsive to the determining step in the PHY layer model; and
deriving from the ascertaining step the sending capacity in the presence of multiple interferers, packet collision probability in the presence of multiple interferers and available capacity in a given link for a corresponding link delivery ratio.

2. The method of claim 1, wherein the input requires pair wise O(N) measurements where N is the number of nodes in the 802.11 wireless network.

3. The method of claim 1, wherein the link capacity model for the single interferer is based on statistics about how much a 802.11 based wireless node defers for a given value on a sender side of the PHY layer model.

4. The method of claim 3, wherein the link capacity model for the single interferer is further based on a packet collision probability for a given RSSI value on a receiver side of the PHY layer model.

5. The method of claim 1, wherein how long the MAC layer stays in appropriate states that contribute to link capacity comprises an analytic approach where the network process can move to any one of five states based on a constant probability at the end of a slot, the probabilities depending only on the average behavior of network nodes, deriving steady state equations one for each of n transmitters in the network from formulated ones of the probabilities, and deriving the fraction of time a node in the network is in a transmit state giving transmission capacity of this node from solution of the steady state equations.

6. The method of claim 1, wherein the how long the MAC layer stays in appropriate states that contribute to link capacity comprises a solution of sender side interference that includes determination of c_{Y}, which is the fraction of time nodes in Y transmit together, the nodes in Y transmitting together when every node in Y does not defer for every other node in Y, c_{Y} following the relationship
$${c}_{Y} = {\prod }_{{z}_{i} ∈ Y} ( 1 - {p}_{i}^{Y - {z}_{i}} ) {c}_{i} .$$
where cᵢ is the fraction of time node zᵢ transmits, and pᵢ^{Y} is the conditional probability that when all nodes in Y transmit in a slot, zᵢ defers.

7. The method of claim 6, wherein the how long the MAC layer stays in appropriate states that contribute to link capacity comprises a solution of receiver side interference that includes determination of drᵢ^{j}(Y) as the delivery ratio from zⱼ to zᵢ in presence of the set of interferers Y, relating packet capture probability to SNR, the ratio of the received signal strength and noise., where rssᵢ^{j} denotes the average signal strength of packets received from zⱼ to zᵢ in absence of interference, and drᵢ^{j}(Y) follows the relationship
$${dr}_{i}^{j} ( Y ) = g ( {SINR}_{i}^{j} ( Y ) ) , where {SINR}_{i}^{j} ( Y ) = \frac{{rss}_{i}^{j}}{{\sum }_{k ∈ Y} {rss}_{i}^{k} + noise} .$$
the equation requiring only pairwise measured rss values in the deployed network.

8. The method of claim 1, wherein a sending capacity is determined from a combination of sender side and receiver side interferences in the MAC layer and the overall link capacity in bits per second from a sender zᵢ to receiver x in the presence of a set of interferers Z−{zᵢ} follows the relationship
$${C}_{x}^{{z}_{i}} ( Z - \{ {z}_{i} \} ) = \frac{P}{P + H} \times W \times {\sum }_{Y ∈ 𝒫 ( Z - \{ {z}_{i} \} )} {dr}_{x}^{Y} \times {t}_{\{ {z}_{i} \} ⋃ Y} . \qquad ( 12 )$$
wherein the first term models the header overhead, the second term specifies the channel bit rate and the third term models the above argument.

9. A method comprising the steps of:
creating a PHY layer model in an 802.11 wireless network of deferral which is whether enough interference power is received to indicate a wireless carrier is busy and of packet capture whether a signal to interference noise ratio SINR is high enough for a packet to be received, the deferral and packet capture being responsive to measurements in a one time profiling done for each interface type;
seeding the PHY layer model by link-wise measurement of received signal strength RSS values in a target mesh network,
feeding the PHY layer model to a MAC layer model in the network enabling the MAC layer model amenable to numeric solution evaluating how long the MAC layer stays in appropriate states that contribute to capacity.

10. The method of claim 9, wherein the RSS values are measured by having each node taking turn and sending a set of broadcast packets, for a given broadcasting sender, rest of the nodes record RSS.

11. The method of claim 11, wherein for an N node network, the measurement requires O(N) measurements steps and provides metrics for all the N(N-1) links in the network.

12. The method of claim 9, wherein the solution comprises at least one of an analytic method and a simulation, the analytic method translating the MAC layer model to a set of equations that are solved using numeric methods and the simulation following the MAC layer model.
